(19) United States
(12) Patent Application Publication
(10) Pub. No.: US 2016/0084311 A1
(43) Pub. Date: Mar. 24, 2016

(54) ROLLING-ELEMENT BEARING CAGE

(71) Applicants: Rico Dittmar, Schweinfurt (DE); Volker Wendt, Uchtelhausen/Zell (DE)

(72) Inventors: Rico Dittmar, Schweinfurt (DE); Volker Wendt, Uchtelhausen/Zell (DE)

(73) Assignee: Aktiebolaget SKF, Goteborg (SE)

(21) Appl. No.: 14/864,053

(22) Filed: Sep. 24, 2015

(30) Foreign Application Priority Data
Sep. 24, 2014 (DE) 10 2014 219 311.7

(51) Int. Cl. F16C 33/46; F16C 19/36

(52) U.S. Cl. CPC F16C 33/4676; F16C 19/364; F16C 33/4629

(57) ABSTRACT

A rolling-element bearing cage includes first and second axially spaced side rings and a plurality of bridges disposed between the first and second side rings. A pair of circumferentially adjacent bridges defines with the first and second axially spaced side rings a receiving pocket configured to receive a rolling element, and each of the plurality of bridges has first and second axially spaced running surfaces. The first and second running surfaces are disposed at first and second axially spaced end regions of the receiving pocket, and a circumferentially recessed region is disposed between the end regions such that a rolling element in a receiving pocket does not contact the recessed region.

### CROSS-REFERENCE

This application claims priority to German patent application no. 10 2014 219 311.7 filed on Sep. 24, 2015, the contents of which are fully incorporated herein by reference.

### TECHNOLOGICAL FIELD

The disclosure relates to a rolling-element bearing cage comprising two axially spaced side rings. A number of bridges extend between the side rings, and each pair of circumferentially adjacent bridges, together with the side rings, defines a receiving pocket for a rolling element.

The sides of the bridges that are configured to face a rolling element in the pocket include running surfaces or contact surfaces.

### BACKGROUND

In cages of the above-mentioned type the bridges form running surfaces or contact surfaces in the circumferential direction for rolling elements placed in the receiving pockets, and these running surfaces help guide the rolling elements. The larger the contact area is between the running surfaces and the rolling elements, the better the rolling elements are guided. In particular, a larger surface area reduces or substantially prevents a rattling or joggling of the rolling elements in the receiving pockets. Disadvantageously, however, an increased contact area also generates relatively high friction when the bearing operates, in part because grease used for lubrication has to be pressed/forced through narrow gaps, gaps between the rolling elements and the running surfaces, for example.

### SUMMARY

One aspect of the disclosure is to improve a rolling-element bearing cage of the above-mentioned type so that it can effectively guide rolling elements located in the receiving pockets while ensuring relatively low-friction running. Furthermore, the service life of the lubricant should be as long as possible, and the disclosed cage design may help prolong lubricant service life.

An aspect of the disclosure comprises disposing the running surfaces in the two axial end regions of the receiving pockets and disposing a recessed region between those running surfaces. The recessed region is configured such that the portion of the rolling element facing the recessed region does not contact the recessed region of the bridge. In other words, the rolling elements only contact the bridges at the running surfaces (contact surfaces) located at axially opposite ends of the bridges on opposite sides of the recessed region.

The side rings and the bridges are preferably formed one-piece with one another.

The recessed region preferably extends over the entire radial height of the bridge.

The recessed region furthermore preferably extends over at least 50% of the axial length of the receiving pocket.

In the disclosed embodiments, the axial lengths of the running surfaces at both axial end regions are preferably the same. However, it can also be advantageous if the axial lengths of the running surfaces are different.

The axial length of the running surface is preferably from 5% to 25% of the axial length of the receiving pocket, particularly preferably from 10% to 20%. In this way an optimal compromise is achieved between a) effective guidance of the rolling elements in a manner that minimizes joggling and b) the amount of friction or resistance to roller movement created by the bridges.

The recessed regions are preferably produced by performing a punching or a stamping or a cutting operation on a cage with bridges that have not yet been provided with recessed regions.

Of course, the proposed cage can also be manufactured from plastic, by injection molding, for example. In this case the injection mold would be configured to produce the recessed regions in the bridges.

The rolling-element bearing cage is preferably formed from metal plate—that is, as a metal-plate cage. It is particularly preferably a tapered roller bearing cage.

Another aspect of the disclosure comprises a first side ring, a second side ring axially spaced from the first side ring, and a plurality of bridges connecting the first side ring to the second side ring. A circumferentially adjacent pair of the plurality of bridges defines, with the first and second axially spaced side rings, a receiving pocket configured to receive a rolling element. Each of the plurality of bridges includes a first running surface and a second running surface axially spaced from the first running surface and a first circumferentially recessed region between the first running surface and the second running surface.

In another aspect of the disclosure, the first recessed regions are configured such that a rolling element mounted in the rolling-element bearing cage contacts the first and second running surfaces without contacting the recessed region.

In a further aspect of the disclosure, the first running surface is spaced from the first side ring by a gap.

In still another aspect of the disclosure each of the plurality of bridges includes a third running surface and a fourth running surface axially spaced from the third running surface by a second circumferentially recessed region, the third running surface being circumferentially spaced from the first running surface and the fourth running surface being circumferentially spaced from the second running surface.

The proposed rolling-element bearing cage thus reduces an area of contact between cage bridges and rolling elements, in particular in the case of tapered roller bearing cages. As a consequence bearing friction is reduced.

It has been shown that the regions where the cage bridges transition to the end side surfaces on which the rollers run strongly affect the tendency of the rolling elements to rattle or joggle and that such joggling can best be prevented by suitably configuring these end regions. Accordingly the disclosure provides that these end regions are used for guiding the rolling element in the receiving pocket, while the bridge portions between these end regions is withdrawn or recessed so that there is no contact here between the cage pocket and the rolling element. Rather, a safe distance between the cage and the roller is ensured in these recessed areas.

Bearing friction is reduced by the disclosed design. Furthermore, grease shearing in the recessed region is reduced, and this advantageously increases grease service life.

A rolling-element bearing including a cage as disclosed advantageously generates less friction and thus less frictional heat so that the lubricant is also heated less. This in turn also helps to increase the service life of the lubricant, and in greased bearings, this leads directly to an increase in bearing service life.

### BRIEF DESCRIPTION OF THE DRAWINGS

Exemplary embodiments of the invention are depicted in the following drawings.

FIG. 1 is a perspective view of a tapered roller bearing cage according to an embodiment of the disclosure.

FIG. 2 is a detail view of Region “X” in FIG. 1.

FIG. 3 is a radial view of one pocket of the tapered roller bearing cage of FIG. 1.

### DETAILED DESCRIPTION

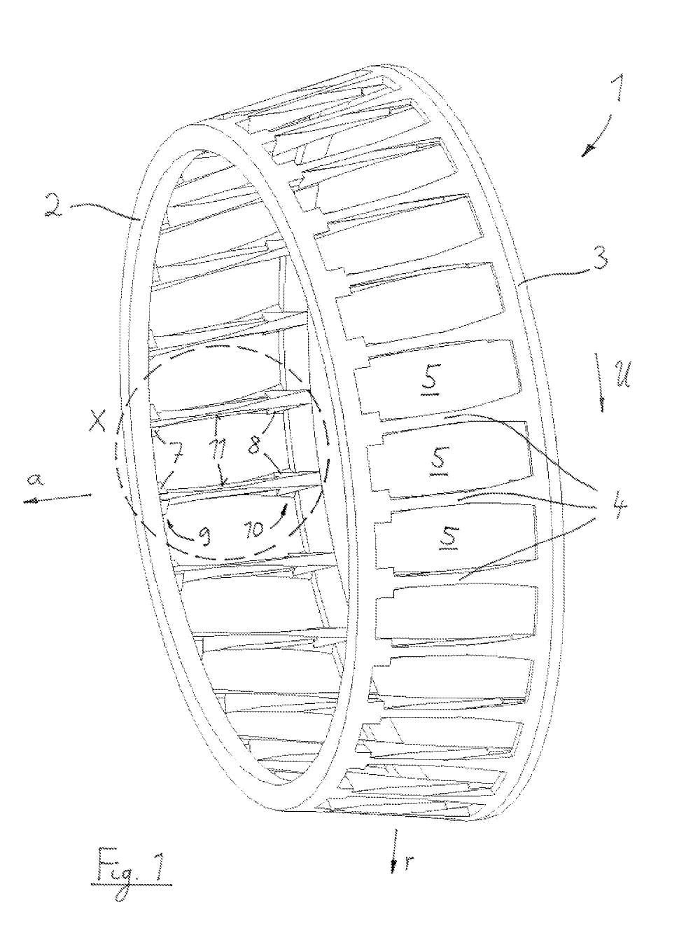

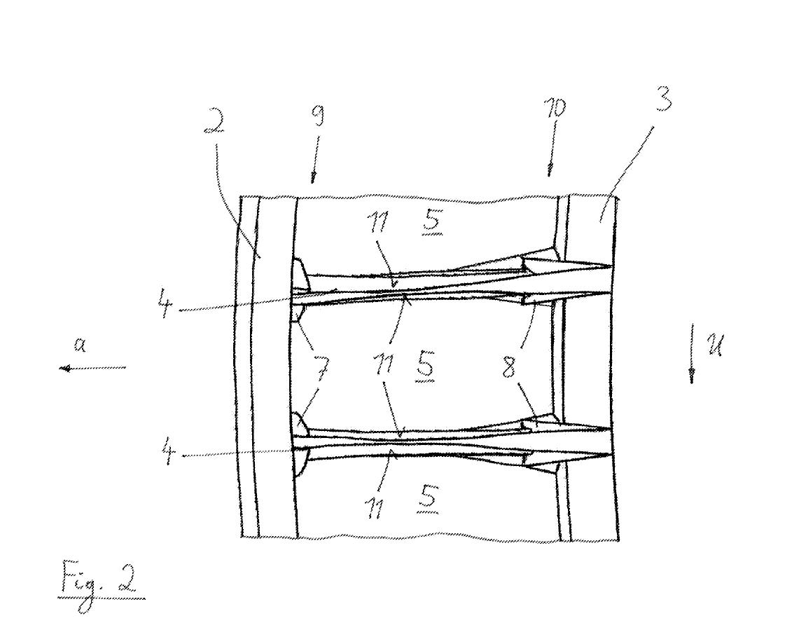

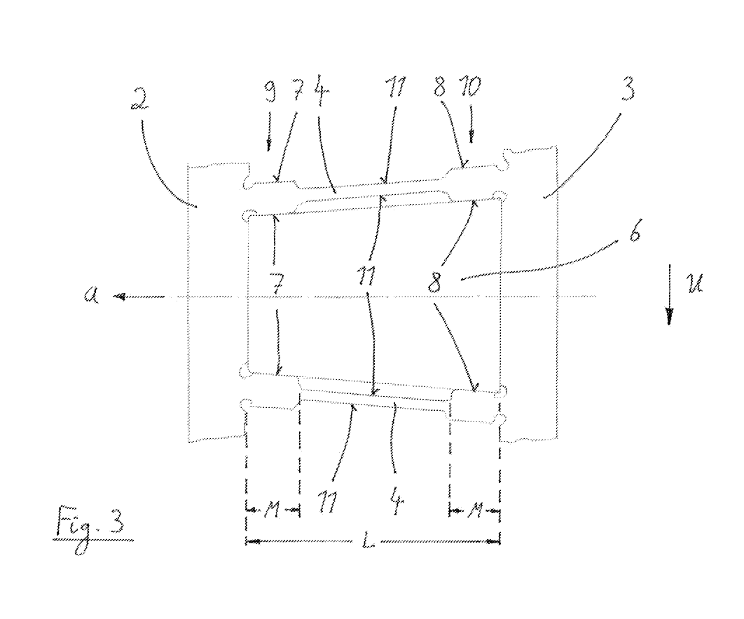

FIG. 1 and the detail view of FIG. 2 depict a tapered roller bearing cage 1. The cage includes two (first and second) side rings 2 and 3 that are axially spaced by a pre-specified distance in an axial direction a. A plurality of bridges 4 extend between the side rings 2, 3. Each circumferentially adjacent pair of bridges 4 (in circumferential direction U) form a receiving pocket 5 for a rolling element 6 (which element is only depicted in FIG. 3).

In order to provide optimal guiding of the rolling element 6 located in one of the receiving pockets 5, running surfaces (contact surfaces) 7 and 8 are formed on axially spaced ends of the bridges 4, which running surfaces 7 and 8 come into contact with the rolling element 6 and serve to guide the rolling element 6. As can be seen in particular in FIG. 3, the running surfaces 7 and 8 are not provided over the entire axial extension of the bridges 4, but they are only present in the axial end regions 9 and 10 of the receiving pocket 5. A recessed region 11 is located on the bridge 4 between the running surfaces 7 and 8, which recessed region 11 ensures that when the rolling element 6 is in the receiving pocket 5, the recessed region 11 of the bridge 4 does not come into contact with the rolling element 6.

FIG. 3 is shown to scale and thus allows relative geometric dimensions of the aforementioned elements to be inferred. Accordingly the receiving pocket 5 has an axial length L, and the axial length M of each of the running surfaces 7 and 8 is preferably from 5% to 25% of the axial length L of the receiving pocket 5.

Preferably the recessed region 11 extends along at least 50% of the axial length L of the receiving pocket 5.

The rolling-element bearing cage 1 can be manufactured from a metal-plate part by reshaping or punching. The recessed regions 11 on the bridges 4 can then also be correspondingly manufactured by punching. This provides for a simple manufacturing method.

The disclosed cage design allows for optimal guidance of rolling elements located in the receiving pockets 5. In particular, the tendency of the rolling elements to joggle in the receiving pocket is minimized because the rolling elements only contact the bridges on their axial ends. Accordingly only small forces, which are transmitted from the running surfaces 7, 8 to the rolling elements, are sufficient to exert sufficient torque (the vector of which is perpendicular to the drawing plane according to FIG. 3) on the rolling elements.

However, the presence of the recessed region 11 allows lubricant to flow with little restriction in the recessed region so that the service life of the lubricant is increased due to lower shear.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing cages.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Rolling-element bearing cage
2 Side ring
3 Side ring
4 Bridge
5 Receiving pocket
6 Rolling element
7 Running surface
8 Running surface
9 Axial end region
10 Axial end region
11 Recessed region
a Axial direction
U Circumferential direction
r Radial direction
L Axial length of the receiving pocket
M Axial length of the running surface

What is claimed is:

1. A rolling-element bearing cage, comprising:
first and second axially spaced side rings,
a plurality of bridges disposed between the first and second side rings,
a pair of circumferentially adjacent bridges of the plurality of bridges defining with the first and second axially spaced side rings a receiving pocket configured to receive a rolling element, each of the plurality of bridges including first and second axially spaced running surfaces,
wherein the first and second running surfaces are disposed at first and second axially spaced end regions of the receiving pocket and wherein a circumferentially recessed region is disposed between the end regions such that the rolling element in the receiving pocket does not contact the recessed region.

2. The rolling-element bearing cage according to claim 1, wherein the first and second side rings and the plurality of bridges are formed one-piece with one another.

3. The rolling-element bearing cage according to claim 1, wherein the recessed region extends over an entire radial height of the plurality of bridges.

4. The rolling-element bearing cage according to claim 1, wherein the recessed region extends over at least 50% of an axial length of the receiving pocket.

5. The rolling-element bearing cage according to claim 1, wherein an axial length of the first running surface is the same as an axial length of the second running surface.

6. The rolling-element bearing cage according to claim 1, wherein an axial length of the first running surface is different than an axial length of the second running surface.

7. The rolling-element bearing cage according to claim 1, wherein an axial length of the first running surface is from 5% to 25% of an axial length of the receiving pocket.

8. The rolling-element bearing cage according to claim 1, wherein the recessed region is generated by a punching operation or by a cutting operation.

9. The rolling-element bearing cage according to claim 1, comprising a metal-plate cage.

10. The rolling-element bearing cage according to claim 1, comprising a tapered roller bearing cage.

11. The rolling-element bearing cage according to claim 1,
wherein the first and second side rings and the plurality of bridges are formed one-piece with one another,
wherein the recessed region extends over an entire radial height of the plurality of bridges and over at least 50% of an axial length of the receiving pocket,
wherein an axial length of the first running surface is the same as an axial length of the second running surface, and is from 5% to 25% of an axial length of the receiving pocket, and
wherein the bearing cage is formed from a metal plate and comprises a tapered roller bearing cage.

12. A rolling-element bearing cage, comprising:
a first side ring,
a second side ring axially spaced from the first side ring,
a plurality of bridges connecting the first side ring to the second side ring,
a circumferentially adjacent pair of the plurality of bridges defining with the first and second axially spaced side rings a receiving pocket configured to receive a rolling element,
wherein each of the plurality of bridges includes a first running surface and a second running surface axially spaced from the first running surface and a first circumferentially recessed region between the first running surface and the second running surface.

13. The rolling-element bearing cage according to claim 12, wherein the first recessed regions are configured such that a rolling element mounted in the rolling-element bearing cage contacts the first and second running surfaces without contacting the recessed region.

14. The rolling-element bearing cage according to claim 12, wherein the first running surface is spaced from the first side ring by a gap.

15. The rolling-element bearing cage according to claim 12, wherein each of the plurality of bridges includes a third running surface and a fourth running surface axially spaced from the third running surface by a second circumferentially recessed region, the third running surface being circumferentially spaced from the first running surface and the fourth running surface being circumferentially spaced from the second running surface.

16. The rolling-element bearing cage according to claim 15, wherein the first recessed region and the second recessed region extend over an entire radial height of the plurality of bridges.

17. The rolling-element bearing cage according to claim 16, wherein the first running surface is spaced from the first side ring by a first gap and the third running surface is spaced from the first side ring by a second gap.

18. The rolling-element bearing cage according to claim 17, wherein the first recessed region and the second recessed region extend over at least 50% of an axial length of the receiving pocket.

19. The rolling-element bearing cage according to claim 18, wherein an axial length of the first running surface is the same as an axial length of the second running surface.
